(19) United States
(12) Patent Application Publication
(10) Pub. No.: US 2026/0134758 A1
(43) Pub. Date: May 14, 2026

(54) COMPUTER-IMPLEMENTED METHOD AND SYSTEM FOR MULTI-PLAYER ONLINE MAP-BASED REAL MONEY WAGER GAMING

(71) Applicant: M-LEAGUE LTD., SINGAPORE (SG)

(72) Inventors: Sai Srinivas Kiran GARIMELLA, Bangalore (IN); Kaustubh BHOYAR, Bangalore (IN); Divyanshu GROVER, Bangalore (IN); Tarun Singh BISHT, Bangalore (IN)

(21) Appl. No.: 19/388,030

(22) Filed: Nov. 13, 2025

(30) Foreign Application Priority Data
Nov. 13, 2024 (IN) 202411087374

(51) Int. Cl. G07F 17/32

(52) U.S. Cl. CPC G07F 17/3276; G07F 17/3237; G07F 17/3269

(57) ABSTRACT

The present invention discloses a computer-implemented method (100) includes receiving, via a network interface, a game entry request along with an associated real-money transaction processed by wallet module (204) to convert into in-game currency, executing, via a matchmaking engine, a room assignment engine (206) configured to allocate a player to active multiplayer session from dynamically maintained whitelist of rooms, initiating, via spatial gameplay engine (208), a real-time rendering and interaction session in assigned room, executing, via a server-side validation module, action results based on player interactions, maintaining, via a synchronization module, a consistent game state across distributed clients using delta state updates and activating, via exit engine (212), a secure removal routine triggered by verified player navigation to a predefined digital location designated as exit zone within map interface to ensures asynchronous latency-tolerant multiplayer interaction while preserving consistent and synchronized gameplay state across distributed clients.

### FIELD OF THE INVENTION

The present invention relates to methods and systems for playing real-money wager game. More particularly, the present invention relates to a computer-implemented method and system for allowing a plurality of players to play an online map-based real money wager game despite one or more player of the plurality of players allotted with a wallet having a predetermined amount.

### BACKGROUND OF THE INVENTION

Traditionally, multiplayer games have a set format where players are paired off in real-time simultaneously, and performance of players are determined at the end of a fixed-duration game.

In recent years, there has been growing interest in real-money wagering games that allows the players to place predetermined number of money/bets while initiating the game and accordingly the player receives the potential rewards based on their final game score or ranking.

However, these real-money wager games having lots of drawbacks which may include but not limited to restrict the player's ability to engage dynamically with the game environment, as many of the times, the outcomes of the game are usually determined based on a limited set of metrics like kill count, score, or overall placement at the conclusion of the game.

One such invention which is a real-money wager game is disclosed in the U.S. Pat. No. 8,795,084.

The said 084' patent discloses a methods and systems disclosed herein include a gaming platform that may support massively-multiplayer online computer games, with elements of social networking, in which players may use mobile devices in order to verify their location and claim a measure of control over the location. Players may function like game pieces in association with other members on a team and participate in competitions to capture and defend real-world territory as part of the gaming experience. The gaming platform and associated entities may share revenue and other incentives with entities associated with the locations controlled by the players on the game platform.

One more such invention is disclosed in the U.S. Pat. No. 8,651,961.

The said 961' patent discloses a method and system tracks, analyses or sorts of behaviours of user or players across a network to draw correlations from, or characterizations of, those user or players and identifies similarly characterized or mutually complementary user or players.

The method automatically obtains player data regarding interactions by each of multiple players with a multiplayer electronic game via each player's corresponding data processing device connected via the network. The method can then sort, classify or suggest additional activities, games, groups, or other different activities or actions for the players.

Moreover, one more such invention is disclosed in the United States publication no. 20040143852.

The said publication discloses a MMORPG according to the invention contains one or more features designed to reduce game predictability, increase the variety of activities a player can pursue, and enhance player versus player experience. Such features include a hybrid MMORPG with both persistent and non-persistent areas, limited access areas, player controlled areas, multiple types of creature spawns, object spawns, player-controlled or programmed NPC's, one time world events, programmed “botting” of player characters, creature effects on environment, simulated artificial intelligence for NPC's dialogs, non-experience based levelling, database driven randomly generated quests, non-experienced based levelling, user-programmable sound effects, database-driven randomly generated encounters, alignment in an MMORPG, temporary NPC companions, formations for purposes of temporary character collision detection, special effect sites, duelling, player apprentices, special purpose guilds, multiplayer emotes, multiple tier server realms, mini-battlegrounds, limited player access areas, PvP battlegrounds with access limited by player population, and terrain based stealth and hiding abilities. These can be used in combination to provide a more interesting MMORPG game experience.

Some prior art/patent research relating to this invention are as follows:

| S. No. | Document No. | Title of Invention | Filing Date |
|---|---|---|---|
| 1. | U.S. Pat. No. | Computer networked game system utilizing | 2004 Dec. 30 |
| | 7,094,154B2 | subscription based membership and alternative | |
| | | methods of entry | |
| 2. | U.S. Pat. No. | In-room game promotion and demonstration | 2002 Sep. 11 |
| | 7,083,520B2 | method and system | |
| 3. | WO2017100778A1 | System and method for providing a secondary | 2016 Dec. 12 |
| | | contest dependent on the results of a primary | |
| | | game | |
| 4. | U.S. Pat. No. | System and method for controlling the | 2022 Oct. 10 |
| | 11,972,666B1 | operation of a game device | |

In conventional real-money wager game, plurality of players are often required to wait for a match to start with all the players present. The final result is determined at the end of the game session, creating restrictions in player engagement, as player only got encouragement by their performance over a certain period of time.

Moreover, these traditional systems do not allow for continuous play or decision-making related to in-game environment, or sector-based actions that effect their monetary rewards.

Therefore, there is a need for a computer-implemented method and a system that enables the players to wager money in real-time within a game map rather than relying at the end of the game result.

Moreover, there is a need for a computer-implemented method and a system that enables the players to enter in the game at different time zones, continuing play on the same map based on their entry fees or prior performance.

Further, there is a need for a computer-implemented method and a system that where players rewards are based on their performance in the game and strategically exit from the game map.

Furthermore, there is a need for a computer-implemented method and a system that provides the players more dynamic game environment.

Additionally, there is a need for a computer-implemented method and a system that allows the players to play continuously on a single map with real-time money wagering opportunities.

In a nutshell, a computer-implemented method and system for playing real money wager game which may overcome the above discussed drawbacks and problems and provide easy and efficient ways of playing the said games.

### SUMMARY OF THE INVENTION

In an aspect of the present invention, a computer-implemented method for enabling asynchronous, skill-based, real-money multiplayer wager game within a spatial map-based environment is disclosed.

In the embodiment of the present invention, the first step of the method involves receiving, via a network interface, a game entry request along with an associated real-money transaction processed by a wallet module to convert into in-game currency.

In another embodiment of the present invention, the followed step of the method involves executing, via a matchmaking engine, a room assignment engine configured to allocate a player to an active multiplayer session from a dynamically maintained whitelist of rooms. The room selection is based on real-time system parameters comprising number of active participants in each room, unclaimed in-game assets tracked by a server-side, cumulative in-game currency held by current player and dynamically computed player skill metrics based on historical game data and recent latency-adjusted interaction scores.

Moreover, the room assignment engine determines players by a real-time performance scoring algorithm derived from historical in-game metrics, recent win and loss ratios, and latency-adjusted response times to assign players to suitable rooms.

Furthermore, the collision detection engine comprises a spatial data processing module configured to determine in real-time a collision between the player avatars and activate a graphical attack mode with associated in-game currency of the opponent player deduction based on server-side validation to prevent client manipulation.

Moreover, the attack and defend transition is handled via a game timer engine that applies time-triggered state which toggles in a uniform manner across all active clients to prevent manipulation and ensure fairness.

In another embodiment of the present invention, the followed step of the method involves initiating, via a spatial gameplay engine, a real-time rendering and interaction session in the assigned room. The engine configured to provides a navigable map-based interface, manages player interaction with server-side detection logic and triggers mode transitions including attack and defend mode based on a time-synchronized game time engine without player intervention.

Moreover, the spatial gameplay engine manages collectible in-game assets via server-side logic, and attributes temporary enhancements to player statistics based upon system-verification.

In another embodiment of the present invention, the followed step of the method involves executing, via a server-side validation module, action results based on player interactions comprising updating in-game currency upon validation of system-registered interactions and detecting spatial collisions via a server-side collision detection engine and applying corresponding outcome logic.

In another embodiment of the present invention, the followed step of the method involves maintaining, via a synchronization module, a consistent game state across distributed clients using delta state updates.

In another embodiment of the present invention, the followed step of the method involves activating, via an exit engine, a secure removal routine triggered by system-detected depletion of in-game currency and verified player navigation to a predefined digital location designated as an exit zone within the map interface. The method ensures asynchronous latency-tolerant multiplayer interaction while preserving consistent and synchronized gameplay state across distributed clients.

Moreover, the exit engine monitors player location data map to detect arrival at predetermined exit zones and triggers a secure exit procedure that transmits the final in-game currency balance to the server for post-game reconciliation.

In another embodiment of the present invention, a computer implemented system for enabling a multiplayer map-based real-money gaming environment is disclosed.

In one embodiment of the present invention, a system comprises a player profile database configured to store player historical game data, and skill metrics.

In another embodiment of the present invention, the system further comprises a wallet module configured to process real money and in-game currency management, convert real money into in-game currency and manage in-game currency balance deductions based on validated gameplay outcomes.

In another embodiment of the present invention, the system further comprises a room assignment engine comprises a matchmaking engine configured to select suitable rooms from a real-time updated whitelist based on historical in-game metrics, recent win and loss ratios, and latency-adjusted response times, and load distribution algorithms.

Moreover, the matchmaking engines assign players to suitable rooms with historical in-game metrics, skill scores within a computed variance range to maintain competitive in-game currency balance and ensure fairness level.

In another embodiment of the present invention, the system further comprises a spatial gameplay engine configured to real-time rendering and interaction session in the assigned room, navigable map-based interface, manage game state synchronization via delta state updates and triggers periodic state transitions including attack and defend mode via time-synchronized game time engine without player intervention.

Moreover, the spatial gameplay engine comprises a synchronized game timer to manage automatic state changes between gameplay modes without human intervention.

Furthermore, the spatial gameplay engine comprises an end game timer module configured to end session after a predetermined interval to ensure fair termination regardless of in-game currency state.

In another embodiment of the present invention, the system further comprises a collision detection engine configured to validate interaction server-side to apply appropriate in-game outcomes to prevent manipulation in the gameplay from client device.

In another embodiment of the present invention, the system further comprises an exit engine configured to trigger system-detected depletion of in-game currency to remove players from the gameplay session upon complete in-game currency depletion, and verify exits based on player navigation to exit coordinates rendered within the environment.

Moreover, the exit engine comprises a verification module to navigate players to a predefined digital location as an exit zone within the map interface.

This together with the other aspects of the present invention along with the various features of novelty that characterize the present disclosure is pointed out with particularity.

For a better understanding of the present disclosure, its operating advantages, and the specified objective attained by its uses, reference should be made to the accompanying descriptive matter in which there are illustrated exemplary embodiments of the present invention.

### DESCRIPTION OF THE DRAWINGS

The advantages and features of the present invention will become better understood with reference to the following detailed description taken in conjunction with the accompanying drawings, in which:

FIG. 1 illustrates a flow chart representing a computer-implemented method for enabling asynchronous, skill-based, real-money multiplayer wager game within a spatial map-based environment, according to various embodiments of the present invention;

FIG. 2 illustrates a block diagram showing a computer-implemented system of a gameplay, according to various embodiments of the present invention;

FIG. 3 illustrates a schematic view of a gameplay showing players on map, according to various embodiments of the present invention;

FIG. 4 illustrates a schematic view of a gameplay of the players competing with the opponents in the map-based game, according to various embodiments of the present invention;

FIG. 5 illustrates a schematic view of a gameplay of the players collecting the in-game currency by defeating the opponents in the map-based game, according to various embodiments of the present invention;

FIG. 6 illustrates a schematic view of a gameplay of the players exiting the map, according to various embodiments of the present invention;

FIG. 7 illustrates a flow chart of a room assignment engine, according to various embodiments of the present invention;

FIG. 8 illustrates a flow chart of a spatial gameplay engine, according to various embodiments of the present invention, and

FIG. 9 illustrates a flow chart of an exit engine, according to various embodiments of the present invention.

Like numerals denote like elements throughout the figures.

### DESCRIPTION OF THE INVENTION

The exemplary embodiments described herein detail for illustrative purposes are subjected to many variations. It should be emphasized, however, that the present invention is not limited to as disclosed.

It is understood that various omissions and substitutions of equivalents are contemplated as circumstances may suggest or render expedient, but these are intended to cover the application or implementation without departing from the spirit or scope of the present invention.

Specifically, the following terms have the meanings indicated below.

The terms “a” and “an” herein do not denote a limitation of quantity, but rather denote the presence of at least one of the referenced items.

The terms “having”, “comprising”, “including”, and variations thereof signify the presence of a component.

More specifically, the technical terms used herein are to be understood as commonly known by those skilled in the field.

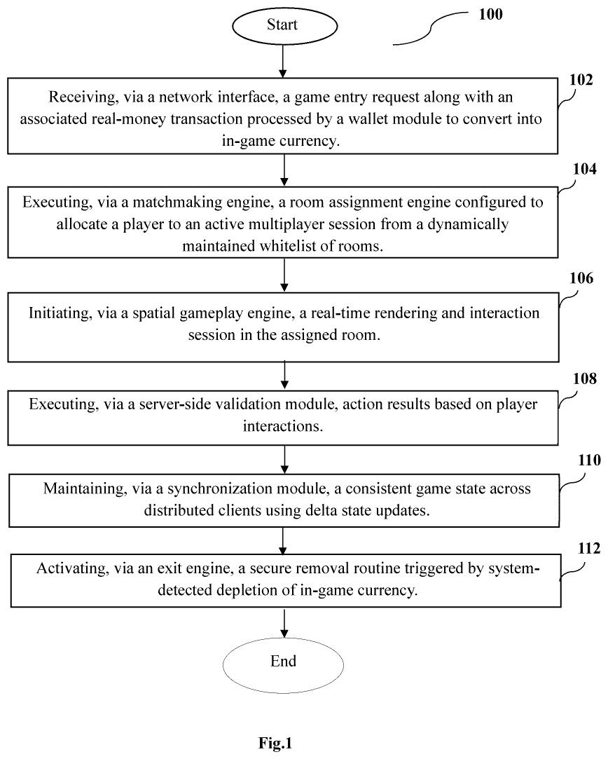

The inventive aspects of the invention along with various components and engineering involved will now be explained with reference to FIGS. 1-9 herein.

In an aspect of the present invention, a computer-implemented method (100) for enabling asynchronous, skill-based, real-money multiplayer wager game within a spatial map-based environment is disclosed.

In an exemplary embodiment of the present invention, the “plurality of players” herein refers to an individual who engage in map-based real money game by buying into a game. The players are assigned to a specific game room as per the skill level of the player.

Moreover, the “suitable game room” herein refers to a virtual environment within the map-based game where players are allowed to interact and compete with each other. The game room has a specific number of players and a set amount of earnings available to be claimed. Also, the process of room assignment is dynamically updated as per the skill level of the player for the gameplay.

Furthermore, the “opponents” herein refers to the other players within the same game room who are competing with each other for the in-game assets. When the opponents come in contact with each other, they lose their in-game currency, which is then collected by the other player.

Moreover, the “in-game currency” herein refers to the earnings that the players collect with the game room. The players are allowed to collect the in-game currency by competing with the opponents to collect more in-game currency than the other players. The total in-game currency in the room is dynamically updated as per the player's action. The winning of any player in the game depends upon how much in-game assets the player has collected.

Furthermore, the “in-game assets” herein refers to a virtual objects/tools that is associated with each player while competing with the opponent. When a player's weapon come in contact with the opponent, the opponent loses the in-game currency.

Furthermore, the “exit zones” herein refers to a specified area that allows the players to exit the game. The exit zones are visually marked on the map which also allows the players to leave the room before their in-game currency is completely depleted.

Furthermore, the “in-game currency” herein refers the virtual currency or gaming currency which the players use within the game. The in-game currency determines the player's presence in the game. Players are allowed to leave the game from the specified exit ports.

Referring to FIG. 1, the method (100) begins with step 102, which involves receiving, via a network interface, a game entry request along with an associated real-money transaction which is processed by a wallet module (204) to convert into in-game currency.

Referring to FIG. 1, the method (100) follows with step 104, which involves executing, via a matchmaking engine, a room assignment engine (206) configured to allocate a player to an active multiplayer session from a dynamically maintained whitelist of rooms.

Moreover, the room selection is based on real-time system parameters comprising number of active participants in each room, unclaimed in-game assets tracked by a server-side, cumulative in-game currency held by current player and dynamically computed player skill metrics based on historical game data and recent latency-adjusted interaction scores.

Furthermore, the room assignment engine (206) determines players by a real-time performance scoring algorithm which is derived from historical in-game metrics, recent win and loss ratios, and latency-adjusted response times for assign players to suitable rooms.

Referring to FIG. 1, the method (100) follows with step 106, which involves initiating, via a spatial gameplay engine (208), a real-time rendering and interaction session in the assigned room. The engine configured to provides a navigable map-based interface, manages player interaction with server-side detection logic and triggers mode transitions including attack and defend mode based on a time-synchronized game time engine without player intervention.

Moreover, the collision detection engine (210) comprises a spatial data processing module configured to determine in real-time a collision between player avatars and activate a graphical attack mode with associated in-game currency of the opponent player deduction based on server-side validation for preventing client manipulation in the gameplay.

Furthermore, the attack and defend transition is handled via a game timer engine which is configured to apply time-triggered state which toggles in a uniform manner across all active clients to prevent manipulation and ensure fairness in the gameplay.

Moreover, the spatial gameplay engine (208) manages collectible in-game assets via server-side logic and assigns a temporary enhancement to player statistics based upon system-verification.

Referring to FIG. 1, the method (100) follows with step 108, which involves executing, via a server-side validation module, action results based on player interactions comprising updating in-game currency upon validation of system-registered interaction and detecting spatial collisions via a server-side collision detection engine (210) and applying corresponding outcome logic.

Referring to FIG. 1, the method (100) follows with step 110, which involves maintaining, via a synchronization module, a consistent game state across distributed clients using delta state updates.

Referring to FIG. 1, the method (100) follows with step 112, which involves activating, via an exit engine (212), a secure removal routine triggered by system-detected depletion of in-game currency and verified player navigation to a predefined digital location designated as an exit zone within the map interface, thereby ensuring asynchronous latency-tolerant multiplayer interaction while preserving consistent and synchronized gameplay state across distributed clients.

Moreover, the exit engine (212) monitors player location data maps to detect arrival at predetermined exit zones and triggers a secure exit procedure that transmits the final in-game currency balance to the server for post-game reconciliation.

In another embodiment of the present invention, a computer implemented system (200) for enabling a multiplayer map-based real-money gaming environment is disclosed.

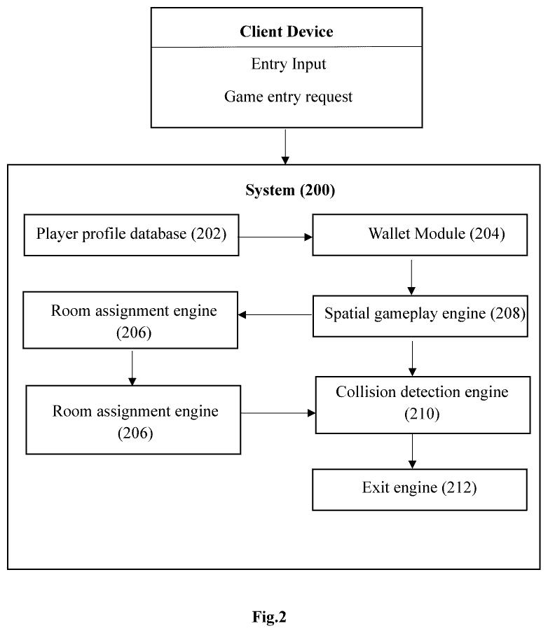

Referring to FIG. 2, a system (200) comprises a player profile database (202) configured to store player historical game data, and skill metrics, a wallet module (204) configured to process real money and in-game currency management, convert real money into in-game currency and manage in-game currency balance deductions based on validated gameplay outcomes.

In another embodiment of the present invention, the system (200) further comprises a room assignment engine (206) comprises a matchmaking engine configured to select suitable rooms from a real-time updated whitelist based on historical in-game metrics, recent win and loss ratios, and latency-adjusted response times, and load distribution algorithms.

Moreover, the matchmaking engines assign players to suitable rooms with historical in-game metrics, skill scores within a computed variance range to maintain competitive in-game currency balance, thereby ensuring fairness level of the gameplay.

In an exemplary embodiment of the present invention, the method of a room assignment engine (206) is explained in below chart 1.

In another embodiment of the present invention, the system (200) further comprises a spatial gameplay engine (208) configured to real-time rendering and interaction session in the assigned room, navigable map-based interface, manage game state synchronization via delta state updates and triggers periodic state transitions including attack and defend mode via time-synchronized game time engine without player intervention.

Moreover, the spatial gameplay engine (208) comprises a synchronized game timer to manage automatic state changes between gameplay modes such as attack and defend mode without human intervention.

Furthermore, the the spatial gameplay engine (208) comprises an end game timer module is configured to end session after a predetermined interval of time, thereby ensuring fair termination regardless of in-game currency state.

In another embodiment of the present invention, the system (200) further comprises a collision detection engine (210) which is configured to validate interaction server-side to apply appropriate in-game outcomes to prevent manipulation in the gameplay from client device.

In another embodiment of the present invention, the system (200) further comprises an exit engine (212) is configured to trigger system-detected depletion of in-game currency which aids in removing players from the gameplay session upon complete in-game currency depletion. Also, the exit engine (212) verifies exits based on player navigation to exit coordinates rendered within the map environment.

Moreover, the exit engine (212) comprises a verification module to navigate player to a predefined digital location as an exit zone integrated within the map interface of the gameplay.

In an exemplary embodiment of the present invention, in case of asymmetric entry fees, the players are assigned the same amount of in-game currency, but the value of each currency is determined by the entry fee paid by the player. For example, if player A and player B entered the game after paying USD 5 and USD 10 respectively as entry fee, player A would be assigned 10 units of in-game currencies of USD 0.5 each and player B would be assigned 10 units of in-game currencies of USD 1 each.

In an exemplary embodiment of the present invention, the system (200) flow is initiated as player A opens the game app and logs in, a wallet module (204) deducts USD 50 from player A's real-money wallet and converts it into 500 units of in-game currency, then a player profile database (202) retrieves player A's skill metrics and historical game data such as performance, win-loss ratio, etc.

Moreover, a room assignment engine (206) which uses the matchmaking engine is configured to select an optimal room for player A by player current skill score, historical game data, players win and loss ratio, latency optimization and as per the crowd in each room via load distribution logic. Player A is placed in room X with players B, C, and D having similar skill levels and response time.

Furthermore, a spatial gameplay engine (208) loads the game map and initiates game session with a synchronized game timer which enables player navigation, collectible in-game assets collection, and combat with the opponent players. The delta state synchronization is used to optimize bandwidth by only transmitting changes, as after a certain period, the game automatically switches between “attack”, and “defend” mode by the internal time-synchronized game time engine without human intervention.

Moreover, when player A attacks player B, a server-side collision detection engine (210) validates hits the server-side and deducts in-game currency from the losing player and a game timer engine applies time-triggered state which toggles in a manner across all active clients present on the map to prevent manipulation and ensure fairness of the gameplay.

Furthermore, after predefined interval of time, suppose player A's in-game currency balance is completely depleted. In that case, an exit engine (212) trigger system-detected depletion of in-game currency to remove players from the gameplay session upon complete in-game currency depletion and updates the profile database of the player. Suppose player D finds an in-game assets and navigates to a marked exit zone designated on the map. The exit engine (212) verifies that player D reached the correct digital coordinates on the map.

Moreover, the spatial gameplay engine (208) comprises an end game timer module and ends the game session after every certain period i.e. 10 minutes. The player D ends with 1000 in-game currency. The wallet module (204) converts the in-game currency back into the real money and add the amount to player D's wallet and player's stats is update in player database.

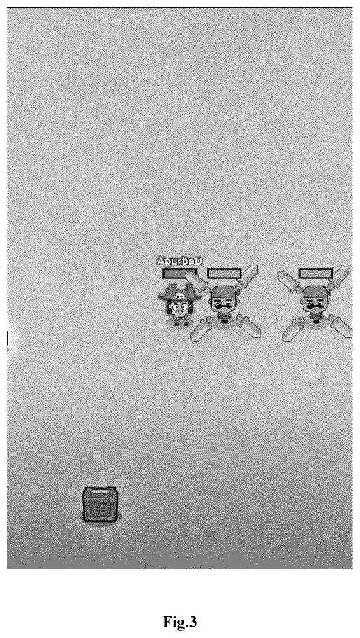

Referring to FIG. 3, illustrates a schematic view of a gameplay showing plurality of players on the map. FIG. 3 herein refers to clients who are engaged in the map-based real money game by buying into a game.

Moreover, the plurality of players is assigned to a specific game room as per the skill level of each player in the gameplay.

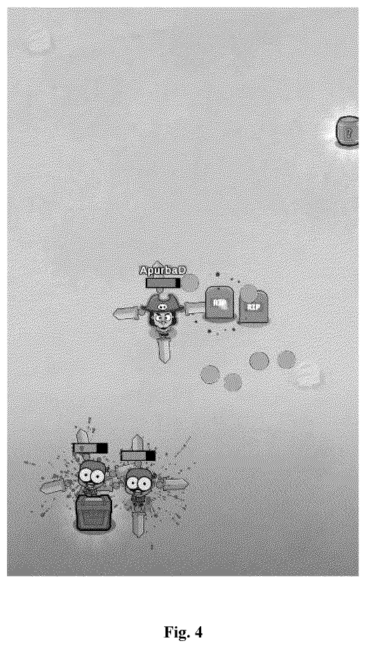

Referring to FIG. 4, illustrates a schematic view of a gameplay of the players competing with the opponents in the specific game room. The specific game room herein refers to a virtual environment within the map-based game where players are allowed to interact and compete with each other.

Moreover, when the opponents come in contact with each other, they lose their in-game currency, which is then collected by the other player in the gameplay.

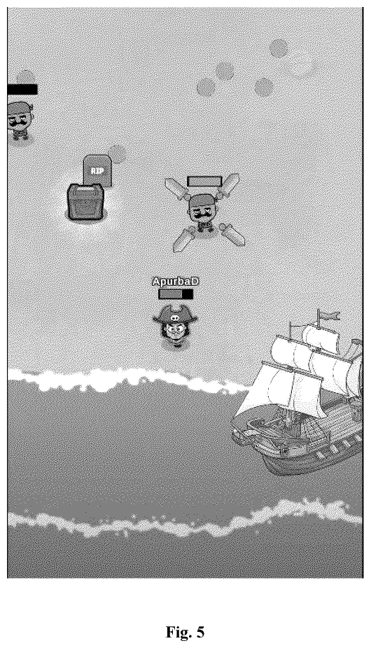

Referring to FIG. 5, illustrates a schematic view of a gameplay of the players collecting the in-game currency by defeating the opponents in the map-based game.

Moreover, the players are allowed to collect the in-game currency by competing with the opponents or by finding the treasure chests. Also, the in-game assets in the room is updated dynamically as per the player's action. The winning of any player in the game depends upon how much in-game asset the player is collected.

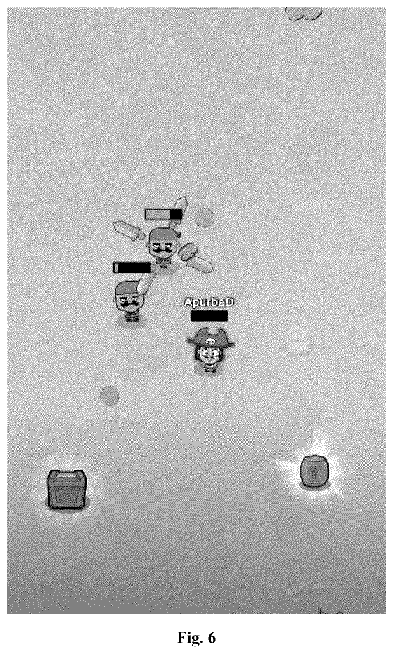

Referring to FIG. 6, illustrates a schematic view of a gameplay of the players exiting the map. The exit ports herein refer to a specified area that allows the players to voluntarily exit the game.

Moreover, the exit ports are marked visually on the map that also allows the players to exit the room before their in-game currency is completely depleted.

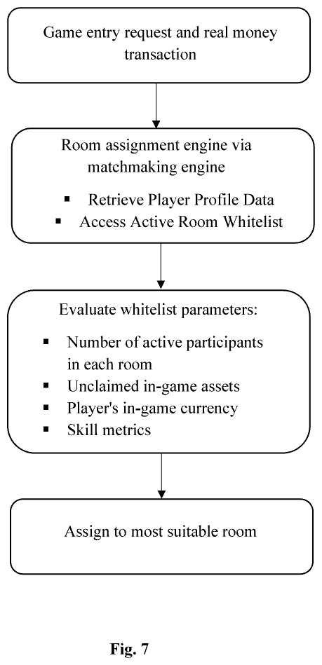

Referring to FIG. 7, illustrates a flow chart of a room assignment engine (206) is disclosed. The flow chart shows the input of game entry request by the player and real money wallet transactions. The engine processes player historical skill level and access a whitelist of active room updated in real-time, evaluate real-time parameters.

Moreover, the parameters are room capacity and, unclaimed in-game assets, cumulative in-game currency held by current player, and dynamically computed player skill metrics based on historical game data and recent latency-adjusted interaction scores, and then assigns to the suitable room using a matchmaking engine.

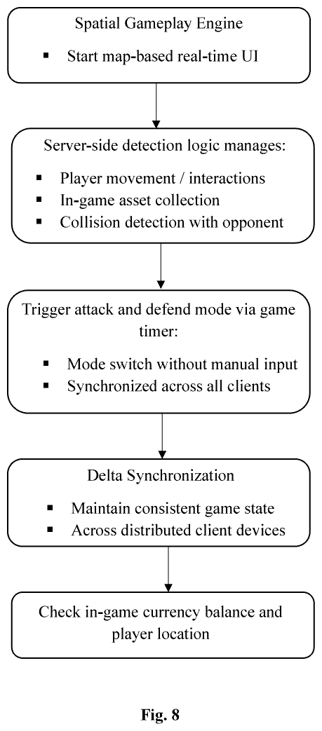

Referring to FIG. 8, illustrates a flow chart of a spatial gameplay engine (208) is disclosed. The flow chart shows the map interface with player movement and in-game assets around the map. The side-servers handles all the movement of the players, engagement with opponent players, and triggers automatic attack and defend mode via a time-synchronized game time engine to ensure fairness in the gameplay.

Moreover, a server-side collision detection engine (210) provides attack mode with in-game currency deductions and uses delta state synchronization updates to propagate only changed state portions across clients, ensuring synchronization in the gameplay.

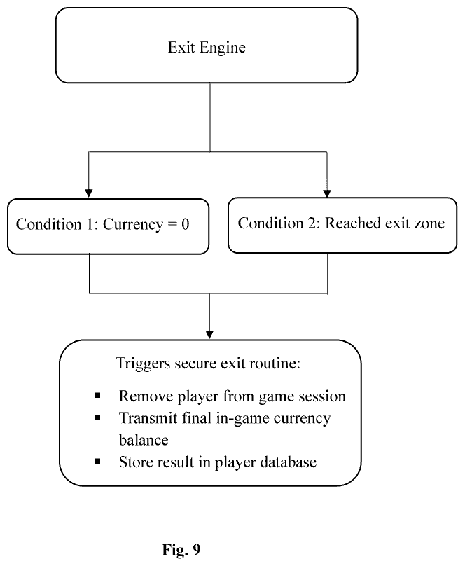

Referring to FIG. 9, illustrates a flow chart of an exit engine (212) is disclosed. The flow chart shows if in-game currency balance of the player is completely depleted, system (200) auto-triggers player removal from the map. On the other hand, the if player navigates to an exit zone which is designated on the map, the engine validates the location and executes the exit of the player from the map that ensures no manipulation at exit stage from a client device.

### Advantageous Effects of the Present Invention

In one embodiment of the present invention, the method and the system of the present invention enables the players to wager money on map-based games.

Moreover, the present invention allows the players to exit the game by just navigating to the specified exit ports that are visually marked on the map.

Lastly, the present invention allows continuous player on a single map with ongoing wagering opportunities based on in-game decision.

In a nutshell, the method and the system of the present invention overcome the drawbacks discussed in the conventional techniques and provided a cost effective, engaging and efficient way of playing a real-money wager game.

The foregoing descriptions of specific embodiments of the present invention have been presented for purposes of description. They are not intended to be exhaustive or to limit the present invention to the precise forms disclosed, and obviously many modifications and variations are possible in light of the above teaching.

Further, the embodiments were chosen and described in order to best explain the principles of the present invention and its practical application, and thereby enable others skilled in the art to best utilize the present invention and various embodiments with various modifications as are suited to the particular use contemplated.

It is understood that various omissions and substitutions of equivalents are contemplated as circumstances may suggest or render expedient, but such omissions and substitutions are intended to cover the application or implementation without departing from the spirit or scope of the present invention.

We claim:

1. A computer-implemented method (100) for enabling asynchronous, skill-based, real-money multiplayer wager game within a spatial map-based environment, wherein the method (100) comprising the steps of:
receiving (at step 102), via a network interface, a game entry request along with an associated real-money transaction processed by a wallet module (204) to convert into in-game currency;
executing (at step 104), via a matchmaking engine, a room assignment engine (206) configured to allocate a player to an active multiplayer session from a dynamically maintained whitelist of rooms, wherein the room selection is based on real-time system parameters comprising:
number of active participants in each room,
unclaimed in-game assets tracked by a server-side,
cumulative in-game currency held by current player, and
dynamically computed player skill metrics based on historical game data and recent latency-adjusted interaction scores;
initiating (at step 106), via a spatial gameplay engine (208), a real-time rendering and interaction session in the assigned room, wherein the engine configured to:
provides a navigable map-based interface,
manages player interaction with server-side detection logic, and
triggers mode transitions including attack and defend mode based on a time-synchronized game time engine without player intervention;
executing (at step 108), via a server-side validation module, action results based on player interactions comprising:
updating in-game currency upon validation of system-registered interactions, and
detecting spatial collisions via a server-side collision detection engine (210) and applying corresponding outcome logic;
maintaining (at step 110), via a synchronization module, a consistent game state across distributed clients using delta state updates; and
activating (at step 112), via an exit engine (212), a secure removal routine triggered by:
system-detected depletion of in-game currency, and
verified player navigation to a predefined digital location designated as an exit zone within the map interface;
wherein the method (100) ensures asynchronous latency-tolerant multiplayer interaction while preserving consistent and synchronized gameplay state across distributed clients.

2. The computer-implemented method (100) as claimed in claim 1, wherein the room assignment engine (206) determines players using a real-time performance scoring algorithm derived from historical in-game metrics, recent win and loss ratios, and latency-adjusted response times to assign players to suitable rooms.

3. The computer-implemented method (100) as claimed in claim 1, wherein the collision detection engine (210) comprises a spatial data processing module configured to determine in real-time a collision between player avatars and activate a graphical attack mode with associated in-game currency of the opponent player deduction based on server-side validation to prevent client manipulation.

4. The computer-implemented method (100) as claimed in claim 1, wherein the attack and defend transition is handled via a game timer engine that applies time-triggered state which toggles in a uniform manner across all active clients to prevent manipulation and ensure fairness.

5. The computer-implemented method (100) as claimed in claim 1, wherein the exit engine (212) monitors player location data map to detect arrival at predetermined exit zones and triggers a secure exit procedure that transmits the final in-game currency balance to the server for post-game reconciliation.

6. The computer-implemented method (100) as claimed in claim 1, wherein the spatial gameplay engine (208) manages collectible in-game assets via server-side logic, and attributes temporary enhancements to player statistics based upon system verification.

7. A computer implemented system (200) for enabling a multiplayer map-based real-money gaming environment, wherein the system (200) comprising:
a player profile database (202) configured to store player historical game data, and skill metrics;
a wallet module (204) configured to:
process real money and in-game currency management,
convert real money into in-game currency, and
manage in-game currency balance deductions based on validated gameplay outcomes;
a room assignment engine (206) comprises a matchmaking engine configured to:
select suitable rooms from a real-time updated whitelist based on historical in-game metrics, recent win and loss ratios, and latency-adjusted response times, and load distribution algorithms;
a spatial gameplay engine (208) configured to:
real-time rendering and interaction session in the assigned room, navigable map-based interface,
manage game state synchronization via delta state updates, and
triggers periodic state transitions including attack and defend mode via time-synchronized game time engine without player intervention;
a collision detection engine (210) configured to validate interaction server-side to apply appropriate in-game outcomes to prevent manipulation in the gameplay from client device; and
an exit engine (212) configured to:
trigger system-detected depletion of in-game currency to remove players from the gameplay session upon complete in-game currency depletion, and
verify exits based on player navigation to exit coordinates rendered within the environment.

8. The computer implemented system (200) as claimed in claim 7, wherein the matchmaking engines assign players to suitable rooms with historical in-game metrics, skill scores within a computed variance range to maintain competitive in-game currency balance and ensure fairness level.

9. The computer implemented system (200) as claimed in claim 7, wherein the spatial gameplay engine (208) comprises a synchronized game timer to manage automatic state changes between gameplay modes without human intervention.

10. The computer implemented system (200) as claimed in claim 7, wherein the exit engine (212) comprises a verification module to navigate player to a predefined digital location as an exit zone within the map interface.

11. The computer implemented system (200) as claimed in claim 7, wherein the spatial gameplay engine (208) comprises an end game timer module configured to end session after a predetermined interval to ensure fair termination regardless of in-game currency state.
